(19) United States
(12) Patent Application Publication
(10) Pub. No.: US 2015/0106841 A1
(43) Pub. Date: Apr. 16, 2015

(54) Dynamic Advertisement During Live Streaming

(71) Applicant: Rhythm NewMedia Inc., Mountain View, CA (US)

(72) Inventors: Amir Wolf, Cupertino, CA (US); Marc Cousineau, San Francisco, CA (US); James T. Morris, San Francisco, CA (US)

(73) Assignee: Rhythm NewMedia Inc., Mountain View, CA (US)

(21) Appl. No.: 14/173,272

(22) Filed: Feb. 5, 2014

Related U.S. Application Data
(60) Provisional application No. 61/890,840, filed on Oct. 14, 2013.

(51) Int. Cl. H04N 21/81

(52) U.S. Cl. CPC H04N 21/812
USPC 725/32

(57) ABSTRACT

Disclosed is a configuration for inserting an advertisement (ad) break into a live stream by a server. One example embodiment includes a system (and method) that receives index files periodically from a media encoder of a live stream. Each index file comprising pointers to current segments of the live stream encoded in real-time. The system sets a status of the live stream to a live status and determines whether an indicator for ad break is included in a received index file. If there is no indicator for the ad break in the received index file, the system transmits the received index file to one or more client computers. If there is an indicator for the ad break in the received index file, the system processes the received index file by removing segments following the indicator from the index file, updates the status of the live stream to an ad-break status, and transmits the processed index file to the one or more client computers.

### CROSS REFERENCE TO RELATED APPLICATIONS

This application claims the benefit of U.S. Provisional Application No. 61/890,840, filed Oct. 14, 2013, which is incorporated by reference in its entirety.

### BACKGROUND

1. Field of Art

The disclosure generally relates to the field of providing dynamic advertisement during live streaming without using video segment replacement.

2. Description of the Related Art

Free or subscription-based video and/or audio streaming has gained more and more popularity in recent years especially on mobile devices. Given the enormous and fast-growing market, advertising during streaming becomes an essential part of streaming technology to sustain and extend the fast-developing business models. For video-on-demand streaming, advertisements can be readily inserted into the on-demand streams at predetermined time intervals. However, this may cause problems for live media streaming. For example, inserting advertisements at predetermined time intervals during a live sport game may interrupt the game abruptly and upset viewers.

Existing techniques to provide advertisement during live streaming often use a method called segment replacement. This method involves the streaming server encodes one or more advertisement segments into the live streaming. Therefore, when advertisement segments are hard-coded into the live stream, there is very limited flexibility with respect to targeting, for example based on the content, length, or target viewers, of advertisements during the live stream.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a block diagram of an example communications environment and system components for providing dynamic advertising during live streaming.

FIG. 2 illustrates one embodiment of components of an example machine able to read instructions from a machine-readable medium and execute them in a processor (or controller).

FIG. 3 illustrates one example embodiment of event trace in an example system for providing dynamic advertisement during live streaming.

FIG. 4 continues to illustrate one example embodiment of event trace in an example system for providing dynamic advertisement during live streaming.

FIG. 5 continues to illustrate one example embodiment of event trace in an example system for providing dynamic advertisement during live streaming.

FIG. 6 continues to illustrate one example embodiment of event trace in an example system for providing dynamic advertisement during live streaming.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system (and a method and a computer readable storage medium) that provides dynamic advertising during live streaming. The system comprises a live encoder, a streaming server and clients. The live encoder encodes live media into a sequence of downloadable segments and generates index files comprising pointers to the sequence of downloadable segments. The streaming server processes the index files and distributes the processed index files to the clients. The client requests and receives the index file, and based on the index files processed by the streaming server, retrieves the live segments for playback. The live encoder inserts ad breaks into the index files to mark the beginning and the end of each ad break. The streaming server identifies the ad-break markers and changes the status of the live stream accordingly. The client stops the live stream when all the segments in the current index file are played and returns the control to an embedded ad-break manager, which queries the status of the live stream. If an “ad-break” status is returned by the streaming server, the ad-break manager plays advertisements until the end of the ad-break is identified.

This dynamic advertisement during live streaming involves coordination between the streaming server and the client. For example, once the streaming server identifies the special marker in the index files indicating the beginning of the ad break, the streaming server sets the status of the live stream to “ad-break” and manipulates the index files so that the client assumes the stream is over after playing the last segment before the ad break. The end event of the media player triggers the ad break manager to issue a query to the streaming server for live stream status. Depending on the status maintained by the streaming server, the ad-break manager may start playing ads, resume the live streaming, or terminate the live stream session.

### Dynamic Ad Playing During Live Streaming

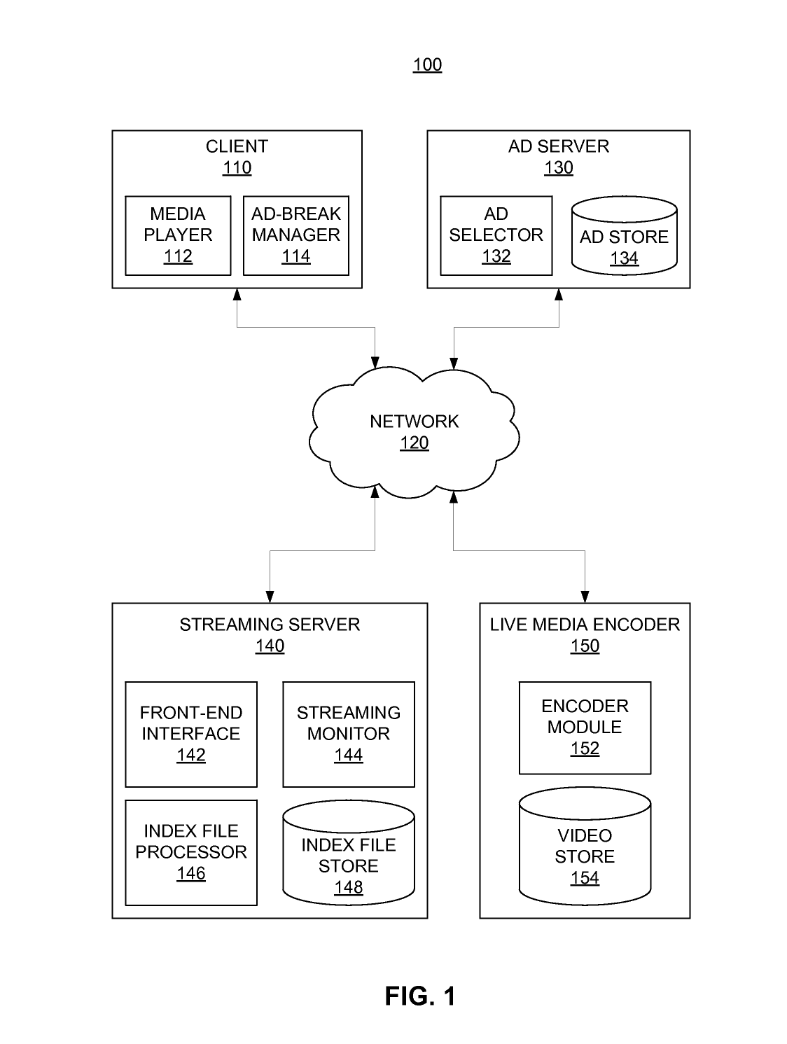

FIG. 1 illustrates a high-level block diagram of an example communications environment 100 for dynamic ad playing during live stream. The environment 100 comprises a client 110, a network 120, an ad (advertisement) server 130, a streaming server 140, and a live media encoder 150. The network 120 is a communication network that transmits data between the client 110, the servers 130 and 140 and the live media encoder 150. In one embodiment, the network 120 is a content distribution network (CDN) including wired or wireless networks and the Internet.

The client 110 can be any computing devices, such as desktops, laptops, netbooks, tablets, smart phones, or personal digital assistants (PDAs). While only one client 110 is illustrated in FIG. 1, the environment 100 may include thousands or millions of such devices. The streaming server 140 and the live media encoder 150 provide live streaming content to client 110 over the network 120. For example, the live media encoder 150 receives the raw live media from a live audio/video input, processes the raw live media to generate a format suitable for live streaming, and passes the information of the processed live media to the streaming server 140 or to any other systems such as a CDN, where streaming server 140 has network access to and can fetch data from. The streaming server 140 receives a request for the live streaming content from the client 110 and distributes the processed live media to the requesting client 110. The distribution of the live media may go through the CDN with a caching period, which correlates to the duration of an index file refresh duration period. The raw media may be any live events, such as sports, concerts, news, TV shows, gaming, or social media that can be processed and streamed live to one or more clients 110. During the live streaming, the live media encoder 150 may also indicate one or more ad-breaks to the streaming server 140, which allows the client 110 to stop, request ads from the ad server 130, and resume the live streaming after playing the ads.

Various streaming protocols, such as FLASH-based streaming, may be deployed in the communications environment 100 for live streaming. In one embodiment, the streaming server 140 and the live media encoder 150 enable HTTP Live Streaming (HLS) of live content. The live media encoder 150 includes an encoder module 152 and a video store 154. The encoder module 152 transcodes the raw media from a live audio/video input to a standardized format, such as H.264 video and AAC, MP3, or AC-3 audio encapsulated in MPEG-2 Transport Streams for delivery to the client. The live media encoder 150 may create a plurality of alternative streams for the same raw media input, each stream corresponding to at least one different encoding parameter, such as resolution, bitrate, and subtitle. For example, the live media encoder 150 may generate two or more streams of the same content with different bitrates. This allows different clients 110 to access or switch between alternative streams of the same media content depending on the configuration of each client 110 (e.g., memory and/or processing power) and/or current network conditions (e.g., available network bandwidth). Details of the HLS and index file format are described in Internet Draft-HTTP Live Streaming (at http://tools.ietf.org/html/draft-pantos-http-live-streaming-11), which is herein incorporated by reference.

The live media encoder 150 also breaks the encoded media data into a sequence of smaller HTTP downloadable files while encoding the raw media and stores the encoded files in the video store 154. Each of these downloadable files comprises a chunk of the media and is referred to as a segment, which is associated with an HTTP URL. The live media encoder 150 produces index files including a number of URLs for the current segments of the live stream and passes the index files to the streaming server 140 for distribution to all the clients 110. In one embodiment, the index files are saved as .m3u8 playlists, which is an extension of the .m3u format used for MP3 playlists. The following shows an example index file that contains 10 segments with a starting sequence No. 52163 and an ending sequence No. 52172 in a live video stream. Each segment in the particular live stream corresponds to a 10 s video encapsulated in a downloadable Transport Streams .ts file.

TABLE 1
Example Index File with Starting Sequence No. 52163

#EXTM3U
#EXT-X-TARGETDURATION:10
#EXT-X-MEDIA-SEQUENCE:52163
#EXTINF:10,
http://hai_live_demo-i.akamaihd.net/hls/live/207461/livedemo/demo_1_300_1031_segment_52163.ts
#EXTINF:10,
http://hai_live_demo-i.akamaihd.net/hls/live/207461/livedemo/demo_1_300_1031_segment_52164.ts
#EXTINF:10,
http://hai_live_demo-i.akamaihd.net/hls/live/207461/livedemo/demo_1_300_1031_segment_52165.ts
#EXTINF:10,
http://hai_live_demo-i.akamaihd.net/hls/live/207461/livedemo/demo_1_300_1031_segment_52166.ts
#EXTINF:10,
http://hai_live_demo-i.akamaihd.net/hls/live/207461/livedemo/demo_1_300_1031_segment_52167.ts
#EXTINF:10,
http://hai_live_demo-i.akamaihd.net/hls/live/207461/livedemo/demo_1_300_1031_segment_52168.ts
#EXTINF:10,
http://hai_live_demo-i.akamaihd.net/hls/live/207461/livedemo/demo_1_300_1031_segment_52169.ts
#EXTINF:10,
http://hai_live_demo-i.akamaihd.net/hls/live/207461/livedemo/demo_1_300_1031_segment_52170.ts
#EXTINF:10,
http://hai_live_demo-i.akamaihd.net/hls/live/207461/livedemo/demo_1_300_1031_segment_52171.ts
#EXTINF:10,
http://hai_live_demo-i.akamaihd.net/hls/live/207461/livedemo/demo_1_300_1031_segment_52172.ts

The streaming server 140 performs a variety of functions including distributing live streaming index files to the clients 110 and maintaining live stream status. In one embodiment, the streaming server 140 and the live media encoder 150 may be operated by the same entity, for example, the entity provides the live streaming content. In other embodiments, the streaming server 140 and the live media encoder 150 are operated by different entities. The live media encoder 150 processes raw live media for live streaming, and passes the index files of the live media to other systems in a CDN, which streaming server 140 has network access to and can fetch data from. The streaming server 140 receives periodical request for refreshed index files from the client 110 and distributes the requested index files to the client 110. The distribution of the live media going through the CDN with a caching period may correlate to the duration of an index file refresh period. Both the streaming server 140 and the live media encoder 150 can be formed of multiple servers. For example, the encoding and distribution functions of the live media encoder 150 may be divided among different sets of servers.

In one embodiment, the streaming server 140 includes a front-end interface module 142, a streaming monitor 144, an index file processor 146, and an index file store 148 for facilitating HLS service. The front-end interface 142 provides functionality allowing the client 102 to access the services of the streaming server 140. For example, the front-end interface 142 may provide a web site that the client 102 can visit to view live streaming videos. Note that the streaming server 140 is shown to ensure clarity and illustrate the embodiment where live streaming videos are provided. Other embodiments may also have the server 140 hosting other content, such as web pages or applications that link to the live content.

The index file processor 146 receives index files from the live media encoder 150 and processes the index files if needed. The index files are then stored in the index file store 148 for distributing to the clients 110. For example, the example index file with starting sequence No. 52163 shown in Table 1 received from the live media encoder 150 contains no special markers, thus, does not need to be processed by the index file processor 146. As a result, the index file can be stored in the index file store 148 and ready to be distributed by the streaming server 140 to the clients 110. Accordingly, the streaming monitor 144 keeps the status of the video stream as “live” (e.g., using a LIVE indicator).

As another example, assuming that in the next moment, the live media encoder 150 inserts an ad-break marker into the live stream and updates the index file as shown below in Table 2. The updated example index file with starting sequence No. 52164 shown in Table 2 includes a beginning of ad-break marker (EXT-X-CUE-OUT) after segments No. 52172 and before segment No. 52173. Different markers can be used to identify the beginning and end of an ad-break in other embodiments. When the streaming server 140 receives this index file, the index file processor 146 identifies the beginning of the ad-break and notifies the ad-break monitor 144, which updates the status of the live stream to “ad-break” status (e.g., using an ADBREAK indicator).

TABLE 2
Example Index File with Starting Sequence No. 52164 from Encoder

#EXTM3U
#EXT-X-TARGETDURATION:10
#EXT-X-MEDIA-SEQUENCE:52164
#EXTINF:10,
http://hai_live_demo-i.akamaihd.net/hls/live/207461/livedemo/demo_1_300_1031_segment_52164.ts
#EXTINF:10,
http://hai_live_demo-i.akamaihd.net/hls/live/207461/livedemo/demo_1_300_1031_segment_52165.ts
#EXTINF:10,
http://hai_live_demo-i.akamaihd.net/hls/live/207461/livedemo/demo_1_300_1031_segment_52166.ts
#EXTINF:10,
http://hai_live_demo-i.akamaihd.net/hls/live/207461/livedemo/demo_1_300_1031_segment_52167.ts
#EXTINF:10,
http://hai_live_demo-i.akamaihd.net/hls/live/207461/livedemo/demo_1_300_1031_segment_52168.ts
#EXTINF:10,
http://hai_live_demo-i.akamaihd.net/hls/live/207461/livedemo/demo_1_300_1031_segment_52169.ts
#EXTINF:10,
http://hai_live_demo-i.akamaihd.net/hls/live/207461/livedemo/demo_1_300_1031_segment_52170.ts
#EXTINF:10,
http://hai_live_demo-i.akamaihd.net/hls/live/207461/livedemo/demo_1_300_1031_segment_52171.ts
#EXTINF:10,
http://hai_live_demo-i.akamaihd.net/hls/live/207461/livedemo/demo_1_300_1031_segment_52172.ts
#EXT-X-CUE-OUT:
#EXTINF:10,
http://hai_live_demo-i.akamaihd.net/hls/live/207461/livedemo/demo_1_300_1031_segment_52173.ts

In one embodiment, the streaming server 140 may stop sending the updated index files to the clients 110 during ad-break, for example, by replying an “HTTP 404 File Not Found” error in response to any index file requests from the clients 110. Alternatively, the index file processor 146 can insert special markers in the index files to indicate end-of-stream to the clients 110. Table 3 below illustrates such an example of index file processed by the index file processor 146 when the ad-break marker (EXT-X-CUE-OUT) between segments No. 52172 and No. 52173 is identified. In this example, the index file processor 146 replaces the ad-break marker (EXT-X-CUE-OUT) and the segment No. 52173 following the ad-break marker with a one second long blank video segment containing only black frames and an end of list marker (EXT-X-ENDLIST).

TABLE 3
Example Processed Index File with Starting Sequence No. 52164 by Server

#EXTM3U
#EXT-X-TARGETDURATION:10
#EXT-X-MEDIA-SEQUENCE:52164
#EXTINF:10,
http://hai_live_demo-i.akamaihd.net/hls/live/207461/livedemo/demo_1_300_1031_segment_52164.ts
#EXTINF:10,
http://hai_live_demo-i.akamaihd.net/hls/live/207461/livedemo/demo_1_300_1031_segment_52165.ts
#EXTINF:10,
http://hai_live_demo-i.akamaihd.net/hls/live/207461/livedemo/demo_1_300_1031_segment_52166.ts
#EXTINF:10,
http://hai_live_demo-i.akamaihd.net/hls/live/207461/livedemo/demo_1_300_1031_segment_52167.ts
#EXTINF:10,
http://hai_live_demo-i.akamaihd.net/hls/live/207461/livedemo/demo_1_300_1031_segment_52168.ts
#EXTINF:10,
http://hai_live_demo-i.akamaihd.net/hls/live/207461/livedemo/demo_1_300_1031_segment_52169.ts
#EXTINF:10,
http://hai_live_demo-i.akamaihd.net/hls/live/207461/livedemo/demo_1_300_1031_segment_52170.ts
#EXTINF:10,
http://hai_live_demo-i.akamaihd.net/hls/live/207461/livedemo/demo_1_300_1031_segment_52171.ts
#EXTINF:10,
http://hai_live_demo-i.akamaihd.net/hls/live/207461/livedemo/demo_1_300_1031_segment_52172.ts
#EXTINF:1.0,
http://devstream.mtv.rnmd.net/mod_iphone/black-black_seqnum_0_dur_1_0.ts
#EXT-X-ENDLIST

Table 4 shows the updated example index file generated by the live media encoder 150 in the next moment with starting sequence No. 52615 when a new segment No. 52174 is added.

TABLE 4
Example Index File with Starting Sequence No. 52165 from Encoder

#EXTM3U
#EXT-X-TARGETDURATION:10
#EXT-X-MEDIA-SEQUENCE:52165
#EXTINF:10,
http://hai_live_demo-i.akamaihd.net/hls/live/207461/livedemo/demo_1_300_1031_segment_52165.ts
#EXTINF:10,
http://hai_live_demo-i.akamaihd.net/hls/live/207461/livedemo/demo_1_300_1031_segment_52166.ts
#EXTINF:10,
http://hai_live_demo-i.akamaihd.net/hls/live/207461/livedemo/demo_1_300_1031_segment_52167.ts
#EXTINF:10,
http://hai_live_demo-i.akamaihd.net/hls/live/207461/livedemo/demo_1_300_1031_segment_52168.ts
#EXTINF:10,
http://hai_live_demo-i.akamaihd.net/hls/live/207461/livedemo/demo_1_300_1031_segment_52169.ts
#EXTINF:10,
http://hai_live_demo-i.akamaihd.net/hls/live/207461/livedemo/demo_1_300_1031_segment_52170.ts
#EXTINF:10,
http://hai_live_demo-i.akamaihd.net/hls/live/207461/livedemo/demo_1_300_1031_segment_52171.ts
#EXTINF:10,
http://hai_live_demo-i.akamaihd.net/hls/live/207461/livedemo/demo_1_300_1031_segment_52172.ts
#EXT-X-CUE-OUT:
#EXTINF:10,
http://hai_live_demo-i.akamaihd.net/hls/live/207461/livedemo/demo_1_300_1031_segment_52173.ts
#EXTINF:10,
http://hai_live_demo-i.akamaihd.net/hls/live/207461/livedemo/demo_1_300_1031_segment_52174.ts

After receiving the index file shown in Table 4 from the live media encoder 150, the index file processor 146 again replaces the ad-break marker (EXT-X-CUE-OUT) and the segments No. 52173 and 52174 following the ad-break marker with a one second long blank video segment containing only black frames tagged by an end of list marker (EXT-X-ENDLIST). Table 5 below illustrates such an example of index file processed by the index file processor 146.

TABLE 5
Example Processed Index File with Starting Sequence No. 52165 by Server

#EXTM3U
#EXT-X-TARGETDURATION:10
#EXT-X-MEDIA-SEQUENCE:52165
#EXTINF:10,
http://hai_live_demo-i.akamaihd.net/hls/live/207461/livedemo/demo_1_300_1031_segment_52165.ts
#EXTINF:10,
http://hai_live_demo-i.akamaihd.net/hls/live/207461/livedemo/demo_1_300_1031_segment_52166.ts
#EXTINF:10,
http://hai_live_demo-i.akamaihd.net/hls/live/207461/livedemo/demo_1_300_1031_segment_52167.ts
#EXTINF:10,
http://hai_live_demo-i.akamaihd.net/hls/live/207461/livedemo/demo_1_300_1031_segment_52168.ts
#EXTINF:10,
http://hai_live_demo-i.akamaihd.net/hls/live/207461/livedemo/demo_1_300_1031_segment_52169.ts
#EXTINF:10,
http://hai_live_demo-i.akamaihd.net/hls/live/207461/livedemo/demo_1_300_1031_segment_52170.ts
#EXTINF:10,
http://hai_live_demo-i.akamaihd.net/hls/live/207461/livedemo/demo_1_300_1031_segment_52171.ts
#EXTINF:10,
http://hai_live_demo-i.akamaihd.net/hls/live/207461/livedemo/demo_1_300_1031_segment_52172.ts
#EXTINF:1.0,
http://devstream.mtv.rnmd.net/mod_iphone/black-black_seqnum_0_dur_1_0.ts
#EXT-X-ENDLIST

Table 6 shows the updated example index file generated by the live media encoder 150 in the next moment with starting sequence No. 52616 when a new segment No. 52175 is added.

TABLE 6
Example Index File with Starting Sequence No. 52166 from Encoder

#EXTM3U
#EXT-X-TARGETDURATION:10
#EXT-X-MEDIA-SEQUENCE:52166
#EXTINF:10,
http://hai_live_demo-i.akamaihd.net/hls/live/207461/livedemo/demo_1_300_1031_segment_52166.ts
#EXTINF:10,
http://hai_live_demo-i.akamaihd.net/hls/live/207461/livedemo/demo_1_300_1031_segment_52167.ts
#EXTINF:10,
http://hai_live_demo-i.akamaihd.net/hls/live/207461/livedemo/demo_1_300_1031_segment_52168.ts
#EXTINF:10,
http://hai_live_demo-i.akamaihd.net/hls/live/207461/livedemo/demo_1_300_1031_segment_52169.ts
#EXTINF:10,
http://hai_live_demo-i.akamaihd.net/hls/live/207461/livedemo/demo_1_300_1031_segment_52170.ts
#EXTINF:10,
http://hai_live_demo-i.akamaihd.net/hls/live/207461/livedemo/demo_1_300_1031_segment_52171.ts
#EXTINF:10,
http://hai_live_demo-i.akamaihd.net/hls/live/207461/livedemo/demo_1_300_1031_segment_52172.ts
#EXT-X-CUE-OUT:
#EXTINF:10,
http://hai_live_demo-i.akamaihd.net/hls/live/207461/livedemo/demo_1_300_1031_segment_52173.ts
#EXTINF:10,
http://hai_live_demo-i.akamaihd.net/hls/live/207461/livedemo/demo_1_300_1031_segment_52174.ts
#EXTINF:10,
http://hai_live_demo-i.akamaihd.net/hls/live/207461/livedemo/demo_1_300_1031_segment_52175.ts

Table 7 below illustrates the example of index file processed by the index file processor 146 after receiving the index file shown in Table 6. The index file processor 146 again replaces the ad-break marker (EXT-X-CUE-OUT) and the segments No. 52173-52175 following the ad-break marker with a one second long blank video segment containing only black frames tagged by an end of list marker (EXT-X-ENDLIST).

TABLE 7
Example Processed Index File with Starting Sequence No. 52166 by Server

#EXTM3 U
#EXT-X-TARGETDURATION:10
#EXT-X-MEDIA-SEQUENCE:52166
#EXTINF:10,
http://hai_live_demo-i.akamaihd.net/hls/live/207461/livedemo/demo_1_300_1031_segment_52166.ts
#EXTINF:10,
http://hai_live_demo-i.akamaihd.net/hls/live/207461/livedemo/demo_1_300_1031_segment_52167.ts
#EXTINF:10,
http://hai_live_demo-i.akamaihd.net/hls/live/207461/livedemo/demo_1_300_1031_segment_52168.ts
#EXTINF:10,
http://hai_live_demo-i.akamaihd.net/hls/live/207461/livedemo/demo_1_300_1031_segment_52169.ts
#EXTINF:10,
http://hai_live_demo-i.akamaihd.net/hls/live/207461/livedemo/demo_1_300_1031_segment_52170.ts
#EXTINF:10,
http://hai_live_demo-i.akamaihd.net/hls/live/207461/livedemo/demo_1_300_1031_segment_52171.ts
#EXTINF:10,
http://hai_live_demo-i.akamaihd.net/hls/live/207461/livedemo/demo_1_300_1031_segment_52172.ts
#EXTINF:1.0,
http://devstream.mtv.rnmd.net/mod_iphone/black-black_seqnum_0_dur_1_0.ts
#EXT-X-ENDLIST

Table 8 shows the updated example index file generated by the live media encoder with starting sequence No. 52176 the next moment when four segments No. 52173-52176 added to the list of segments after the ad-break marker.

TABLE 8
Example Index File with Starting Sequence No. 52167 from Encoder

#EXTM3U
#EXT-X-TARGETDURATION:10
#EXT-X-MEDIA-SEQUENCE:52167
#EXTINF:10,
http://hai_live_demo-i.akamaihd.net/hls/live/207461/livedemo/demo_1_300_1031_segment_52167.ts
#EXTINF:10,
http://hai_live_demo-i.akamaihd.net/hls/live/207461/livedemo/demo_1_300_1031_segment_52168.ts
#EXTINF:10,
http://hai_live_demo-i.akamaihd.net/hls/live/207461/livedemo/demo_1_300_1031_segment_52169.ts
#EXTINF:10,
http://hai_live_demo-i.akamaihd.net/hls/live/207461/livedemo/demo_1_300_1031_segment_52170.ts
#EXTINF:10,
http://hai_live_demo-i.akamaihd.net/hls/live/207461/livedemo/demo_1_300_1031_segment_52171.ts
#EXTINF:10,
http://hai_live_demo-i.akamaihd.net/hls/live/207461/livedemo/demo_1_300_1031_segment_52172.ts
#EXT-X-CUE-OUT:
#EXTINF:10,
http://hai_live_demo-i.akamaihd.net/hls/live/207461/livedemo/demo_1_300_1031_segment_52173.ts
#EXTINF:10,
http://hai_live_demo-i.akamaihd.net/hls/live/207461/livedemo/demo_1_300_1031_segment_52174.ts
#EXTINF:10,
http://hai_live_demo-i.akamaihd.net/hls/live/207461/livedemo/demo_1_300_1031_segment_52175.ts
#EXTINF:10,
http://hai_live_demo-i.akamaihd.net/hls/live/207461/livedemo/demo_1_300_1031_segment_52176.ts

Table 9 illustrates the index file with starting sequence No. 52167 processed by the index file processor 146. Since the live media encoder 150 just updated the index file with more segments without signaling the end of the ad-break, the streaming server 140 maintains the status of the live stream in ad-break status and repeats replacing the ad-break marker (EXT-X-CUE-OUT) and all the segments following the ad-break marker with a one second long blank video segment and an end of list marker (EXT-X-ENDLIST). Note currently the processed index file contains only six segments No. 52167-52172 before the ad-break marker.

TABLE 9
Example Processed Index File with Starting Sequence No. 52167 by Server

#EXTM3U
#EXT-X-TARGETDURATION:10
#EXT-X-MEDIA-SEQUENCE:52167
#EXTINF:10,
http://hai_live_demo-i.akamaihd.net/hls/live/207461/livedemo/demo_1_300_1031_segment_52167.ts
#EXTINF:10,
http://hai_live_demo-i.akamaihd.net/hls/live/207461/livedemo/demo_1_300_1031_segment_52168.ts
#EXTINF:10,
http://hai_live_demo-i.akamaihd.net/hls/live/207461/livedemo/demo_1_300_1031_segment_52169.ts
#EXTINF:10,
http://hai_live_demo-i.akamaihd.net/hls/live/207461/livedemo/demo_1_300_1031_segment_52170.ts
#EXTINF:10,
http://hai_live_demo-i.akamaihd.net/hls/live/207461/livedemo/demo_1_300_1031_segment_52171.ts
#EXTINF:10,
http://hai_live_demo-i.akamaihd.net/hls/live/207461/livedemo/demo_1_300_1031_segment_52172.ts
#EXTINF:1.0,
http://devstream.mtv.rnmd.net/mod_iphone/black-black_seqnum_0_dur_1_0.ts
#EXT-X-ENDLIST

The next index file updated by the live media encoder 150 sees an end of ad-break marker (EXT-X-CUE-IN) after segment No. 52176 and before segment No. 52177. Thus, there are a total of four segments between the beginning and the end of the ad-break markers, indicating that the duration of the ad-break is four segments long (i.e. 40 s), as shown in Table 10.

TABLE 10
Example Index File with Starting Sequence No. 52168 from Encoder

#EXTM3U
#EXT-X-TARGETDURATION:10
#EXT-X-MEDIA-SEQUENCE:52168
#EXTINF:10,
http://hai_live_demo-i.akamaihd.net/hls/live/207461/livedemo/demo_1_300_1031_segment_52168.ts
#EXTINF:10,
http://hai_live_demo-i.akamaihd.net/hls/live/207461/livedemo/demo_1_300_1031_segment_52169.ts
#EXTINF:10,
http://hai_live_demo-i.akamaihd.net/hls/live/207461/livedemo/demo_1_300_1031_segment_52170.ts
#EXTINF:10,
http://hai_live_demo-i.akamaihd.net/hls/live/207461/livedemo/demo_1_300_1031_segment_52171.ts
#EXTINF:10,
http://hai_live_demo-i.akamaihd.net/hls/live/207461/livedemo/demo_1_300_1031_segment_52172.ts
#EXT-X-CUE-OUT:
#EXTINF:10,
http://hai_live_demo-i.akamaihd.net/hls/live/207461/livedemo/demo_1_300_1031_segment_52173.ts
#EXTINF:10,
http://hai_live_demo-i.akamaihd.net/hls/live/207461/livedemo/demo_1_300_1031_segment_52174.ts
#EXTINF:10,
http://hai_live_demo-i.akamaihd.net/hls/live/207461/livedemo/demo_1_300_1031_segment_52175.ts
#EXTINF:10,
http://hai_live_demo-i.akamaihd.net/hls/live/207461/livedemo/demo_1_300_1031_segment_52176.ts
#EXT-X-CUE-IN:
#EXTINF:10,
http://hai_live_demo-i.akamaihd.net/hls/live/207461/livedemo/demo_1_300_1031_segment_52177.ts

After receiving the index file shown in Table 10 from the live media encoder 150, the index file processor 146 identifies the end of ad-break marker (EXT-X-CUE-IN) between segments No. 52176 and No. 52177 and notifies the ad-break monitor 144, which resets the status of the live stream to “live” status (e.g., using an LIVE indicator). The index file processor may notify the ad break monitor to end the ad break only in the following segment or anywhere else based on client minimal requirements for duration in the playlist. Note that some conventional media players require that the duration of the playlist will be at least 3 target durations, as marked in the header tag, so that the index file processor can decide weather to delay the end of the ad break or to pad it with enough black frames. The index file processor 146 also replaces each of the segments before the end of ad-break marker (EXT-X-CUE-IN) with a predefined time interval, e.g., one second (or more), blank video segment tagged by a discontinuity marker (EXT-X-DISCONTINUITY). Table 11 shows the resulting example processed index file with starting sequence No. 52618 including nine blank frames and the discontinuity marker, followed by the updated segment No. 52177.

TABLE 11
Example Processed Index File with Starting Sequence No. 52168 by Server

#EXTM3U
#EXT-X-TARGETDURATION:10
#EXT-X-MEDIA-SEQUENCE:52168
#EXTINF:1.0,
http://devstream.mtv.rnmd.net/mod_iphone/black-black_seqnum_0_dur_1_0.ts
#EXTINF:1.0,
http://devstream.mtv.rnmd.net/mod_iphone/black-black_seqnum_0_dur_1_0.ts
#EXTINF:1.0,
http://devstream.mtv.rnmd.net/mod_iphone/black-black_seqnum_0_dur_1_0.ts
#EXTINF:1.0,
http://devstream.mtv.rnmd.net/mod_iphone/black-black_seqnum_0_dur_1_0.ts
#EXTINF:1.0,
http://devstream.mtv.rnmd.net/mod_iphone/black-black_seqnum_0_dur_1_0.ts
#EXTINF:1.0,
http://devstream.mtv.rnmd.net/mod_iphone/black-black_seqnum_0_dur_1_0.ts
#EXTINF:1.0,
http://devstream.mtv.rnmd.net/mod_iphone/black-black_seqnum_0_dur_1_0.ts
#EXTINF:1.0,
http://devstream.mtv.rnmd.net/mod_iphone/black-black_seqnum_0_dur_1_0.ts
#EXTINF:1.0,
http://devstream.mtv.rnmd.net/mod_iphone/black-black_seqnum_0_dur_1_0.ts
#EXT-X-DISCONTINUITY
#EXTINF:10,
http://hai_live_demo-i.akamaihd.net/hls/live/207461/livedemo/demo_1_300_1031_segment_52177.ts

In the above examples, the live media encoder 150 inserts the special markers identifying the beginning and the end of the ad break into the index files, and the index file processor 146 identifies the special markers and processes the index files accordingly. In an alternative embodiment, the streaming server 140 is notified of ad breaks through out-of-band signals other than the index files. For example, the ad breaks may be marked using the same or different markers in a separate stream synchronized to the corresponding live stream, which is received by the streaming server 140 from the live media encoder 150 or other systems in the CDN.

Referring back to FIG. 1, the client 110 has a media player 112 and an ad-break manager 114 installed. The media players 112 may be native media players or media players embedded in other applications running on the client 110 for playback live video and/or audio streams. In one embodiment, users of the client 110 can access the live video streaming directly from inside the native media player 112. In another embodiment, the media player 112 is embedded in a mobile browser running on the client 110 for retrieving web content with embedded audio and/or video elements including live streams. For example, when accessing HTML5 based web content with embedded live video, the mobile browser can play back the embedded live video within the browser window. In other embodiments, the mobile browser can also invoke the native media player 112 and passes the embedded live video to the media player 112 for playback.

In one embodiment, the media player 112 periodically requests index files for the HLS media through the front-end interface 142 of the streaming server 140. For example, the media player 112 may request for index file with the next starting sequence number every ten seconds. Based on the index files, the media player 112 downloads and plays each of the segments listed in the current index file one by one in order. As discussed above, the client 110 receives a regular index file like the one shown in Table 1 (with starting sequence No. 52163) forwarded by the streaming server 140 without processing. In case an ad-break marker is identified, the index file processor 146 of the streaming server 140 replaces the ad-break marker and all the segments after the ad-break marker in the index file with a one second long blank video segment containing only black frames tagged by an end of list marker before distributing it to the client. For example, after the index file in Table 1 (with starting sequence No. 52163), the client 110 receives, as a next update, the processed index file shown in Table 3 (with starting sequence No. 52164), which contains nine segments before the end of the list marker. Another index file received by the client 110 after three update cycles would be the processed index file in Table 9 (with starting sequence No. 52167) containing six segments.

The ad-break manager 114 is a software module installed in the client 110 to manage the ad-break during the live video and/or audio streaming. The ad-break manager 114 may be integrated into the media player 112. In this case, a software development kit (SDK), such as an application programming interface (API) library and software utilities, is provided to the media player developer to incorporate the ad-break manager functionality into the media player 112. Alternatively, the ad-break manager can be an executable program, such as a JavaScript code, downloaded from the streaming server 140 or other sources to the client 110. For example, when the client 110 requests to play a live stream inside an HTML5 web page, the returned HTML5 web page from the streaming server 140 includes a JavaScript code. The JavaScript code implements functions of the ad-break manager 114, which coordinates the ad playback during the live streaming.

In one embodiment, the ad-break manager 114 monitors the status of media player 112 and communicates with the streaming monitor 144 for the status and other information of the live stream played by the media player 112. The media player 112 continues to play each of the segments in the index files until reaching the end of list marker. For example, there are six segments No. 52167-52172 before the end of list marker in the example index file shown in Table 9. The media player 112 stops after playing the last segment No. 52172. Once detecting that the media player 112 stops, the ad-break manager 114 queries the status of the live stream at the streaming monitor 144 of the streaming server 140. The streaming monitor 144 may return one of the three status of the live stream currently played by the media player 112: live, ad-break, and dead (e.g., represented by LIVE, ADBREAK, and DEAD indicators, respectively). In case a “live” status is returned, the media player 112 restarts the playback of the live media, while a “dead” status terminates the current live streaming session.

When the returned status of the live stream is ad-break, the streaming monitor 144 may also communicate with the ad-break manager 114 about the duration of the ad break, among other information. As a result, the ad-break manager 114 makes an ad request to the ad server 130 for one or more ads to fill the duration of the ad break. The ad server 130 responds with URLs for one or more ads, to the ad-break manager 114, which forwards the URLs to media player 112 to download and play the ads. After the media player 112 have played the ads or while the media player 112 is playing the ads, the ad-break manager 114 sends another query to the streaming monitor 144 for stream status. If the response status of the live stream is still “ad-break”, the ad-break manager 114 repeats the ad request to the ad server 130.

When the response status of the live stream becomes live, the ad-break manager restarts the live streaming playback through the media player 112. Responsive to the index file request, the streaming server 140 sends the media player 112 an index file, for example, the one with starting sequence No. 52168 shown in Table 11. The index file includes nine one second long blank video segments before a discontinuity marker, which is followed by the next live stream segment No. 52177. This allows the media player 112 have around nine seconds to buffer the segment No. 52177 before resuming the playback.

The ad server 130 includes an ad selector 132 and an ad store 134. In other embodiments, the ad server 130 may include additional, fewer, or different components for various applications. The streaming server 140 and the ad server 130 can be either combined or separated. While only one server of each 130, 140, and 250 is shown in the environment 100 of FIG. 1, different embodiments may include multiple streaming servers, ad servers, or video encoders operated by a single entity or multiple entities. In other embodiments, a single server may also provide different functionalities, such as delivering live media content, as well as serving advertisements.

The ad store 134 stores video/audio ads 302 received from advertisers or other third-party entities. In addition, the video ad store 314 may store metadata associated with video/audio ads. The ad metadata identifies or otherwise describes subject matter, genre, length, product or service represented, or any other characteristic of the advertisements. When requested by the clients 110 during the ad-break, the ad selector 132 selects one or more ads from the ad store 134 for playback at the client. The ad selector 132 may select the ads based on content and media type of the current live stream played by the client, and/or information about the client, such as user demography, interest and hobby, social connections, and other characteristic information of the client.

In one embodiment, the ad-break manager 114 and the ad server 130 communicate over standard protocols, such as the Video Ad Serving Template (VAST) from the Interactive Advertising Bureau (IAB). VAST provides a common protocol that enables ad servers to use a single ad response format across multiple publishers or video players. For example, in addition to the URLs of the ads, 114 may also receive URLs for ad interactivity, impression tracking and reporting from the ad server 130 in the same response. Details of the ad server response format and the expected behavior of video players are described in the VAST specification (at http://www.iab.net/media/file/VASTv3.0.pdf), which is herein incorporated by reference.

### Computing Machine Architecture

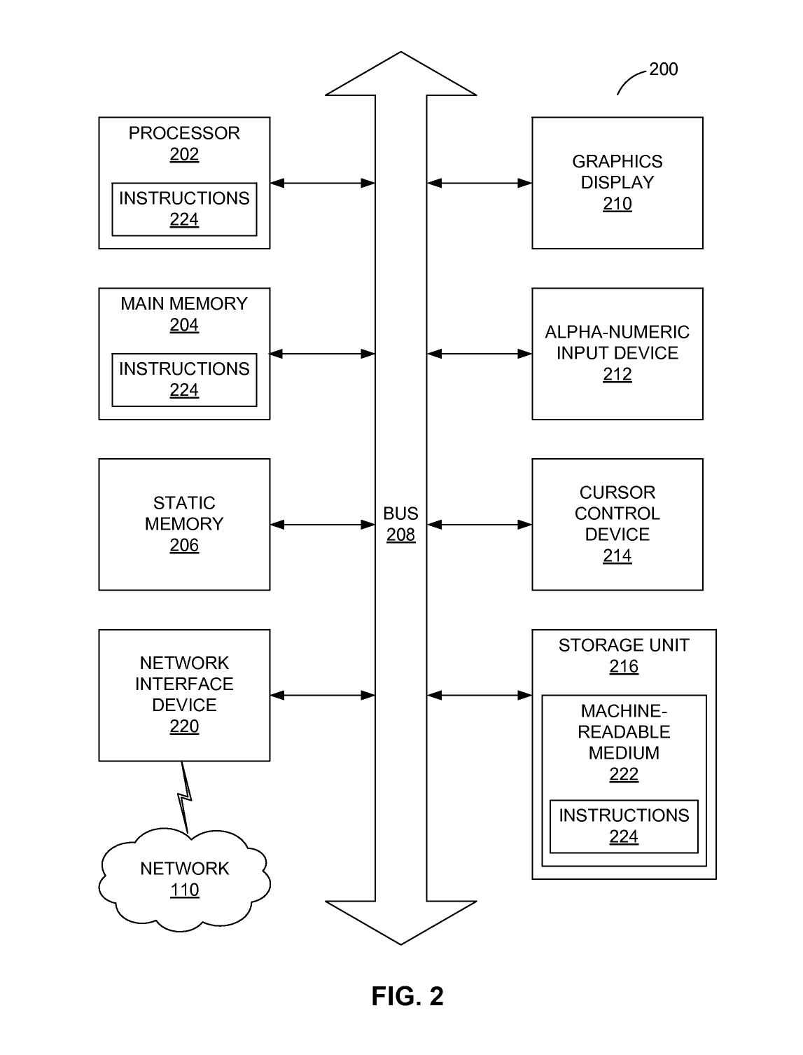

FIG. 2 is a block diagram illustrating components of an example machine able to read instructions from a machine-readable medium and execute them in a processor (or controller) to implement the disclosed systems for dynamic advertisement playing during live streaming, such as the streaming server 140 and the live media encoder 150, the ad server 130, and/or clients 110 in the example communications environment 100 shown in FIG. 1. Specifically, FIG. 2 shows a diagrammatic representation of a machine in the example form of a computer system 200 within which instructions 224 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smart phone, a web appliance, a network router, switch or bridge, or any machine capable of executing instructions 224 (sequential or otherwise) that specify actions to be taken by that machine. Further, while only a single machine is illustrated, the term “machine” shall also be taken to include any collection of machines that individually or jointly execute instructions 224 to perform any one or more of the methodologies discussed herein.

The example computer system 200 includes one or more processors 202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 204, and a static memory 206, which are configured to communicate with each other via a bus 120. The computer system 200 may further include graphics display unit 210 (e.g., a plasma display panel (PDP), a liquid crystal display (LCD), a projector, or a cathode ray tube (CRT)). The computer system 200 may also include alphanumeric input device 212 (e.g., a keyboard), a cursor control device 214 (e.g., a mouse, a trackball, a joystick, a motion sensor, or other pointing instrument), a storage unit 216, and a network interface device 140, which also are configured to communicate via the bus 120.

The storage unit 216 includes a machine-readable medium 222 on which is stored instructions 224 (e.g., software) embodying any one or more of the methodologies or functions described herein. The instructions 224 (e.g., software) may also reside, completely or at least partially, within the main memory 204 or within the processor 202 (e.g., within a processor's cache memory) during execution thereof by the computer system 200, the main memory 204 and the processor 202 also constituting machine-readable media. The instructions 224 (e.g., software) may be transmitted or received over a network 110 via the network interface device 140.

While machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 224). The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

### Interactions Between Systems

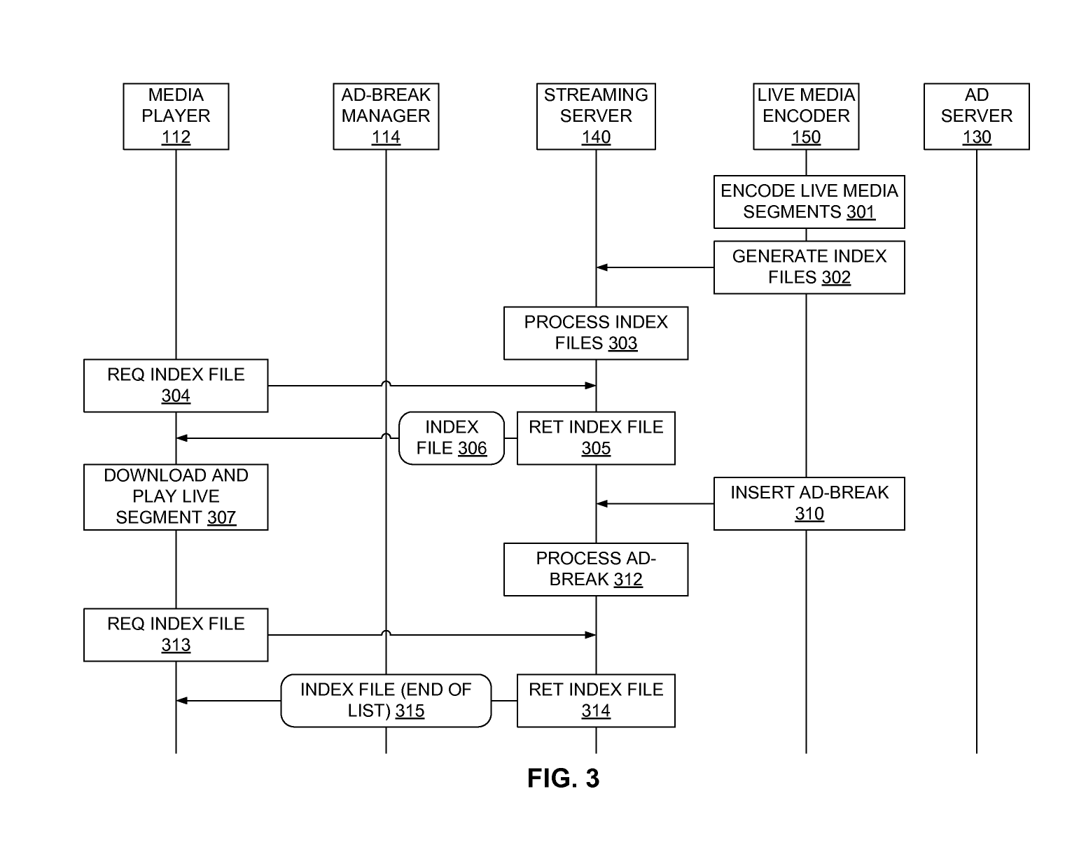

FIG. 3 illustrates one embodiment of event trace 300 in an example environment for providing dynamic advertisement during live streaming according to one embodiment. The various entities are illustrated in boxes along the top of the figure, and time is represented by vertical lines descending from the boxes. Interactions between the entities are represented by horizontal lines. Other embodiments of the method may include different entities, perform the transactions in different orders, and/or perform different interactions. Likewise, the functions described herein may be performed by other entities in other embodiments.

As shown in FIG. 3, the system comprises the media player 112, ad-break manager 114, streaming server 140, live media encoder 150, and ad server 130. The media player 112 and ad-break manager 114 are both installed in the client 110, but are shown as separated modules for the purpose of the description and clarity. In one embodiment, the video encoder 150 encodes 301 media segments for a live streaming and generates 302 index files, which are passed to the streaming server 140 for processing and distribution. The streaming server 140 receives the index files for the live streaming and processes 303 the index files depending on whether special markers are included in the index files. For example, an example index file shown in Table 1 with starting sequence No. 52163 has no special markers and can be readily distributed to the media player 112.

The media player 112 starts the live streaming by requesting 304 the index file from the streaming server 140, which returns 305 a current index file 306 to the client for the requested live stream. After receiving the index file 306, such as the index file shown in Table 1, the media player 112 downloads 307 the next segment that has not been played following the URL in the index file and plays the live segment. As described above, the live media encoder 150 continuously encodes the media segments from the live input and sending updated index files to the streaming server 140. The media player 112 therefore periodically requests for the index file with the latest segments for download and playback. Due to network latency and buffering, there may be a gap between the sequence numbers of the segment played by the media player 112 and the latest segment available in the index file.

The live media encoder 150 may determine to insert 310 one or more ad-break during the live streaming. In one embodiment, the live media encoder 150 marks the beginning an ad-break with the special marker (EXT-X-CUE-OUT) in the index file. For instance, the example index file with a starting sequence No. 52164 shown in Table 2 includes a beginning marker (EXT-X-CUE-OUT) after segment No. 52172. Identifying the beginning marker, the streaming server 140 starts to process 312 the ad-break. The process involves changing the status of the live stream from “live” to “ad-break” at the streaming monitor 144 and replacing the beginning of ad-break marker and all the segments after the ad-break marker in the index file with a one second long blank video segment followed by an end of list marker (EXT-X-ENDLIST). For example, the resulting index file with the starting sequence No. 52164 becomes the one shown in Table 3. When the media player 112 request 313 next index file, the streaming server 140 returns 314 a processed index file 315 with the end of list marker in the last line.

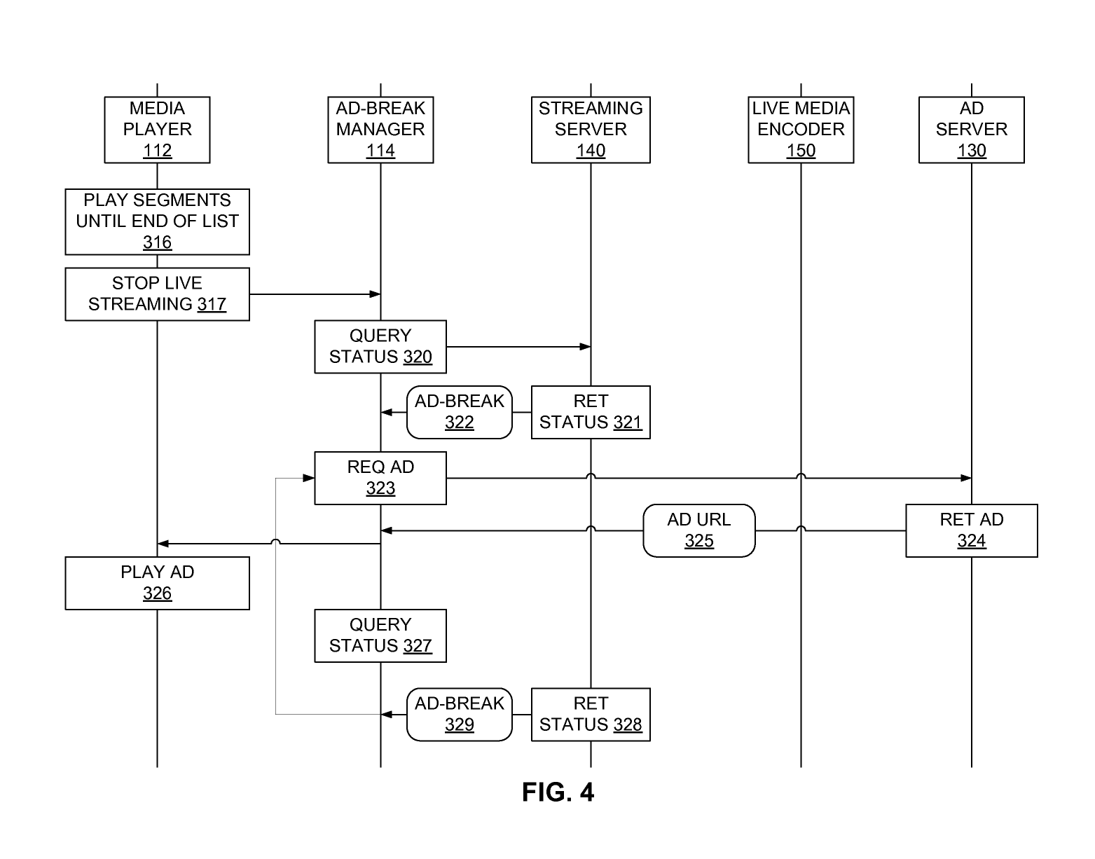

The system interactions continue in FIG. 4. In one embodiment, before the live media encoder 150 notifies the streaming server 140 of the end of the ad-break with another special marker, the streaming monitor 144 maintains the “ad-break” status and the index file processor 146 repeatedly the process of replacing segments after the ad-break marker in the index file with an blank segment tagged by an end of list marker. Such an example index file received by the media player 112 is illustrated in Table 9. The media player 112 continues to play 316 the segments in the index file until reaching the end of list marker and then stops 317 the live streaming. Detecting that the media player 112 is stopped, the ad-break manager 114 makes 320 a query on the status of the live stream to the streaming server 140. In response to the query, the streaming monitor 144 returns 321 status of the live stream, in this case, “ad-break” 322 to the ad-break manager 114. The ad-break manager 114 next requests 323 one or more ads from the ad server 130, which responds 324 with URLs 325 pointing to the ads. The ad-break manager 114 then passes the ad URLs to the media player for downloading and playback 326. After or during the ad playing, the ad-break manager 114 issues another query 327 on the live stream status to the streaming server 140. As shown in the bottom of FIG. 4, the streaming server again returns 328 an “ad-break” 329 status, which causes the ad-break manager 114 to repeat ad request.

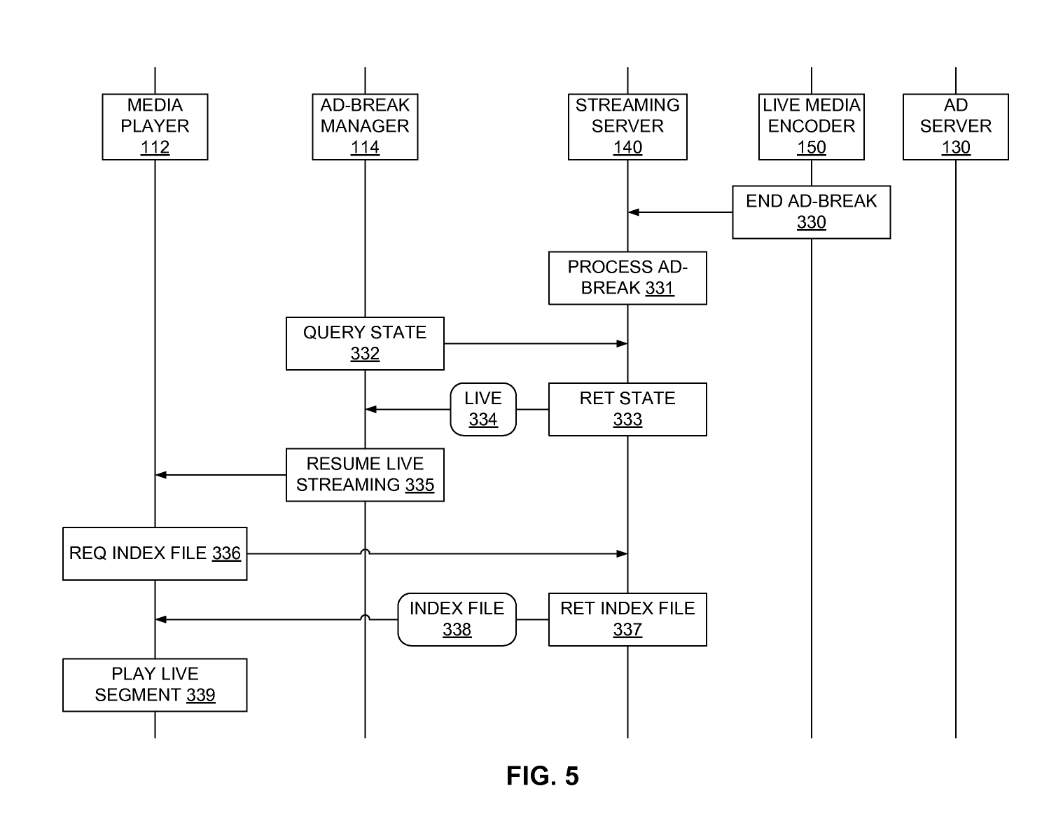

Referring now to FIG. 5. Here, the live media encoder 150 inserts a marker in an index file to indicate the end of the ad-break and sends 330 the index file to the streaming server 140. In one embodiment, the live media encoder 150 marks the end of an ad-break with the special marker (EXT-X-CUE-IN). For instance, the example index file with a starting sequence No. 52168 shown in Table 10 includes a beginning marker (EXT-X-CUE-OUT) after segment No. 52172 and an end marker (EXT-X-CUE-IN) before segment No. 52177. The four segments in between the two markers are to be replaced with ads at the media player of the client. The streaming monitor 144 maintains the status of “ad-break” until the end of ad-break marker is identified in the index file. Once the live streaming server 140 identifies the end of the ad-break marker corresponding to a previous beginning marker, for example, when receiving the example index file shown in Table 10, the streaming monitor 144 resets the status of the live stream back to “live”, and the index file processer 146 process the received index file by replacing each of the segments before the end of ad-break marker with a one second blank video segment tagged by a discontinuity marker (EXT-X-DISCONTINUITY), such as the example index file shown in Table 11.

Afterwards, when the ad-break manager 114 makes 332 yet another query for the live stream status, the streaming server 140 returns 333 a status of “live” 334 in response because the streaming monitor 144 has reset the status after identifying the end of ad-break marker. The ad-break manager 114 subsequently notifies 335 the media player 112 to resume the live streaming. As a result, the media player 112 resumes to request 336 an index file from the streaming server 140, which responds 337 with a current index file 338. An example index file received by the media player 112 immediately after the ad-break is shown in Table 11. The media player 112 downloads 339 the first segment (e.g., segment No. 52177) and plays 339 the live segment. The nine one second blank segments before the discontinuity marker serves as a buffering window for clients that may have joined early.

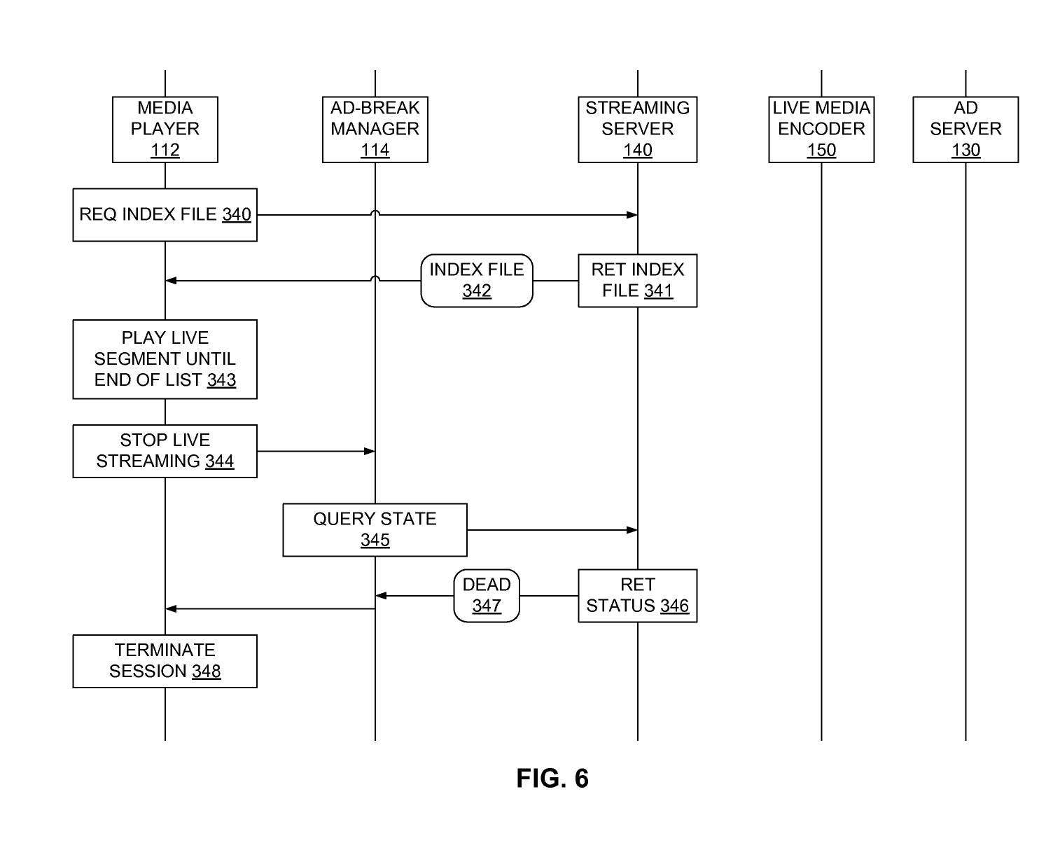

FIG. 6 illustrates further interactions between the systems according to one embodiment. The media player 112 continues to request 340 index file from the streaming server 140, which returns 341 a latest index file 342 to the media player 112 for the current live stream. After receiving the index file 342, the media player 112 downloads and plays 343 the next segment that has not been played following the URLs in the index file until the end of the list. The media player 112 then stops 344, which is detected by the ad-break manager 114. The ad-break manager 114 next makes 345 a query on the status of the live stream to the streaming server 140. In response to the query, the streaming server 140 returns 346 status of the live stream, in this case, “dead” 347 to the ad-break manager 114, which notifies the media player 112 to terminate 348 the live streaming session.

### Additional Configuration Considerations

Benefits and advantages of the disclosed configuration include achieving dynamic advertisement during live streaming, where pre-determined time intervals would not be otherwise practical for advertisement. For example, the configuration beneficially inserts markers in index files to indicate the beginning and the end of the ad break during the live streaming. When the index files are processed by the streaming server, the streaming server identifies the ad-break and coordinates with the client to play ads during the ad-break. In addition, when the ad-break is over, the streaming server replaces all the media segments before the ad-break with a period of blank segment so that clients joined early may have a buffering window. Further, the advertisements are requested by the client from ad servers, which may select ads based on a number of criteria, such as the content and media type of the live stream and/or characteristic information of the viewers.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors 102) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods (e.g., as described with FIGS. 4, 5, 6A, 6B, and 7) described herein may be performed, at least partially, by one or more processors (e.g., processor 102) that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Some portions of this specification are presented in terms of algorithms or symbolic representations of operations on data stored as bits or binary digital signals within a machine memory (e.g., a computer memory 104). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for providing dynamic advertising during live streaming through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for inserting an advertisement (ad) break into a live stream by a server computer, the method comprising:
receiving, at the server computer, index files periodically from a media encoder of a live stream, each index file comprising pointers to current segments of the live stream encoded in real-time;
setting, by the server computer, a status of the live stream to a live status;
determining, by the server computer, whether a received index file includes a special marker;
responsive to the received index file including no special marker, transmitting, by the server computer, the received index file to one or more client computers; and
responsive to the received index file including the special marker and the special marker being an indicator for ad break, the server computer:
processing the received index file by replacing segments following the indicator for ad break from the index file with a segment comprising an indicator for an end of list,
updating the status of the live stream to an ad-break status, and
transmitting the processed index file to the one or more client computers,
wherein the received index file is only processed in response to a detection of the special marker.

2. The method of claim 1, further comprising:
determining, by the server computer, whether the special marker included in the received index file is an indicator for end of the ad break; and
responsive to the special marker being the indicator for end of the ad break, the server computer:
processing the received index file by replacing segments before the indicator for end of the ad break with one or more blank segments,
updating the status of the live stream to the live status, and
transmitting the processed index file to the one or more client computers.

3. The method of claim 2, wherein the one or more blank segments each comprises blank frames of a predefined time interval.

4. The method of claim 1, further comprising:
determining, by the server computer, whether the special marker included in the received index file is an indicator for end of the live stream; and
responsive to the special marker being the indicator for end of the live stream in the in the received index file, the server computer:
updating the status of the live stream to a dead status, and
transmitting the received index file to the one or more client computers.

5. The method of claim 1, further comprising:
receiving a query on the status of the live stream from a client;
determining the status of the live stream, the status being one of a live status, an ad-break status, and a dead status; and
transmitting the status of the live stream to the one or more client computers.

6. The method of claim 5, further comprising:
responsive to a determined ad-break status of the live stream, transmitting the ad-break status of the live stream including a duration of the ad break to the one or more client computers.

7. The method of claim 1, wherein the live stream is based on HTTP live streaming (HLS) protocol.

8. The method of claim 1, wherein the live stream is transmitted through a content delivery network having a caching period correlating to a duration of a refresh duration period of the received index file.

9. A method for playing advertisements (ads) during a live streaming at a client computer, the method comprising:
requesting a live stream from a streaming server, the live stream comprising a sequence of segments encoded in real-time;
receiving an index file comprising a list of pointers to current segments of the live stream, the index file comprising an indicator for an end of list;
playing the current segments of the live stream until the end of the list;
monitoring a status of playing the current segments of the live stream;
querying a status of the live stream from the streaming server in response to detecting playing the current segments of the live stream is stopped;
responsive to a query result indicating an ad-break status, requesting ads from an ad server and playing the ads retrieved from a location received from the ad server;
responsive to a query result indicating a live status, requesting an updated index file and resuming the playback of the live stream; and
responsive to a query result indicating a dead status, terminating the live stream.

10. The method of claim 9, wherein the query result indicating an ad-break status also includes a duration of the ad break.

11. The method of claim 10, wherein requesting ads from the ad server further comprises:
sending the duration of the ad break to the ad server; and
receiving one or more ads for the duration of the ad break.

12. A non-transitory computer-readable storage medium storing executable computer program instructions to cause a processor to insert an advertisement (ad) break into a live stream by a server computer, the computer program instructions comprising instructions to:
receive index files periodically from a media encoder of a live stream, each index file comprising pointers to current segments of the live stream encoded in real-time;
set a status of the live stream to a live status;
determine whether a received index file includes a special marker;
responsive to the received index file including no special marker, transmit the received index file to one or more client computers; and
responsive to the received index file including the special marker and the special marker being an indicator for ad break,
process the received index file by replacing segments following the indicator for ad break from the index file with a segment comprising an indicator for an end of list,
update the status of the live stream to an ad-break status, and
transmit the processed index file to the one or more client computers,
wherein the received index file is only processed in response to a detection of the special marker.

13. The non-transitory computer-readable storage medium of claim 12, further comprising instructions to:
determine whether the special marker included in the received index file is an indicator for end of the ad break; and
responsive to the special marker being the indicator for end of the ad break,
process the received index file by replacing segments before the indicator for end of the ad break with one or more blank segments,
update the status of the live stream to the live status, and
transmit the processed index file to the one or more client computers.

14. The non-transitory computer-readable storage medium of claim 13, wherein the one or more blank segments each comprises blank frames of a predefined time interval.

15. The non-transitory computer-readable storage medium of claim 12, further comprising instructions to:
determine whether the special marker included in the received index file is an indicator for end of the live stream; and
responsive to the special marker being the indicator for end of the live stream in the received index file,
update the status of the live stream to a dead status, and
transmit the received index file to the one or more client computers.

16. The non-transitory computer-readable storage medium of claim 12, further comprising instructions to:
receive a query on the status of the live stream from a client;
determine the status of the live stream, the status being one of a live status, an ad-break status, and a dead status; and
transmit the status of the live stream to the one or more client computers.

17. The non-transitory computer-readable storage medium of claim 16, further comprising instructions to:
responsive to a determined ad-break status of the live stream, transmit the ad-break status of the live stream including a duration of the ad break to the one or more client computers.

18. The non-transitory computer-readable storage medium of claim 12, wherein the live stream is based on HTTP live streaming (HLS) protocol.

19. The non-transitory computer-readable storage medium of claim 12, wherein the live stream is transmitted through a content delivery network having a caching period correlating to a duration of a refresh duration period of the received index file.

20. A non-transitory computer-readable storage medium storing executable computer program instructions to cause a processor to play advertisements (ads) during a live stream transmission to one or more client computers, the computer program instructions comprising instructions to:
request a live stream from a streaming server, the live stream comprising a sequence of segments encoded in real-time;
receive an index file comprising a list of pointers to current segments of the live stream, the index file comprising an indicator for an end of list;
play the current segments of the live stream until the end of the list;
monitor a status of playing the current segments of the live stream;
query a status of the live stream from the streaming server in response to detecting playing the current segments of the live stream is stopped;
responsive to a query result indicating an ad-break status, request ads from an ad server and playing the ads retrieved from a location received from the ad server;
responsive to a query result indicating a live status, request an updated index file and resuming the playback of the live stream; and
responsive to a query result indicating a dead status, terminate the live stream.

21. The non-transitory computer-readable storage medium of claim 20, wherein the query result indicating an ad-break status also includes a duration of the ad break.

22. The non-transitory computer-readable storage medium of claim 21, wherein the instructions to request ads from the ad server further comprises instructions to:
send the duration of the ad break to the ad server; and
receive one or more ads for the duration of the ad break.
